(19) United States
(12) Patent Application Publication
(10) Pub. No.: US 2017/0171752 A1
(43) Pub. Date: Jun. 15, 2017

(54) SECURING SIGNALING INTERFACE BETWEEN RADIO ACCESS NETWORK AND A SERVICE MANAGEMENT ENTITY TO SUPPORT SERVICE SLICING

(71) Applicant: QUALCOMM Incorporated, San Diego, CA (US)

(72) Inventors: Soo Bum Lee, San Diego, CA (US); Stefano Faccin, San Ysidro, CA (US); Gavin Bernard Horn, La Jolla, CA (US); John Nasielski, San Diego, CA (US); Lenaig Chaponniere, La Jolla, CA (US)

(21) Appl. No.: 15/275,245

(22) Filed: Sep. 23, 2016

Related U.S. Application Data
(60) Provisional application No. 62/267,276, filed on Dec. 14, 2015.
(60) Provisional application No. 62/281,673, filed on Jan. 21, 2016.

(51) Int. Cl. H04W 12/06; H04W 12/04

(52) U.S. Cl. CPC H04W 12/06; H04W 12/04; H04W 60/04

(57) ABSTRACT

A method, operational at a radio access network (RAN) node, is provided for establishing a secure interface with a service network node. A service registration request is received from a client device. A service network associated with the connectivity network is determined or ascertained, wherein the service network node operates within the service network. The service registration request is forwarded to a connectivity network node within the connectivity network. A secure connection is then established with a service network node via the connectivity network node. Communications between the radio access network node and the client device may then be secured based on the key.

### RELATED APPLICATIONS

The present application for Patent claims priority to U.S. Provisional Application No. 62/267,276, filed Dec. 14, 2015, and U.S. Provisional App. No. 62/281,673 filed Jan. 21, 2016, both assigned to the assignee hereof and hereby expressly incorporated by reference herein.

### FIELD

The present application is related to methods, systems, and devices that support operation of a single device, which maintains separate and distinct connectivity contexts and service contexts for a user device.

### BACKGROUND

Current wireless systems (e.g., 4G, Long-Term Evolution or LTE, LTE-A, WLAN, Wi-Fi) typically operate in the packet switched domain. Today's wireless systems support only a single subscription/single credential using a single connectivity context between a user device and a connectivity management portion of a network (e.g., a single non-access stratum (NAS) context between a client device (e.g., a user equipment or UE) and a mobility management function (MMF)).

According to some arrangements between service providers and connectivity providers, a service provider may subsidize network usage for their subscribers (e.g., for content streaming etc.), i.e., a service provider may pay for network connectivity usage for services provided by the service provider. Additionally, systems of the future may support separate relationships between a service provider and radio access network operator (RAN) and between the service provider and the core network (CN) operator.

What is needed are methods, devices, and/or systems that permit establishing and using distinct contexts between a user device and connectivity providers and between the user device and service providers to overcome some or all of the drawbacks of the prior art. Additionally, since a service provider may establish its own authentication with client devices, it would be beneficial for a service network node to establish a secure interface with a service Radio Access Node (RAN) rather than rely or trust on an intermediate connectivity provider network.

### SUMMARY

A method operational at a radio access network (RAN) node is provided for establishing a secure interface with a service network node. A first service registration request may be received from a client device. The first service registration request is forwarded to a connectivity network node serving the client device within a connectivity network. A first secure connection may then be established with a first service network node via the connectivity network node, wherein communications over the first secure connection are secured against access by the connectivity network node. In one implementation, the radio access network node may select a service network associated with the connectivity network, wherein the first service network node operates within the service network. The first secure connection may be a tunnel between the radio access network node and the service network node

According to one aspect, different service registrations for the same client device establish different secure connections with one or more service network nodes, and the different secure connections are secured against access by the connectivity network node. For instance, a second service registration request receiving from the client device. The second service registration request may be forwarded to the connectivity network node. A second secure connection with a second service network node may be established via the connectivity network node, wherein communications over the second secure connection are secured against access by the connectivity network node.

In one example, establishing the first secure connection with the first service network node may include: (a) determining whether the radio access network node has a pre-existing secure connection with the first service network node, (b) if the pre-existing secure connection is available, reusing the pre-existing secure connection with the first service network node, and (c) if the pre-existing secure connection is not available, establishing the first secure connection with the first service network node via the connectivity network node.

In another example, establishing the first secure connection with the first service network node includes receiving a secure connection request from the connectivity network node which originated from the service network node.

The method may further include: (a) receiving, from the first service network node over the first secure connection, a key that serves to secure communications between the radio access network node and the client device, and/or (b) securing communications between the radio access network node and the client device based on the key.

In one example, the first service registration request may include a service identifier associated with the service network node or a service. In another example, the first service registration request may be forwarded along with radio access network node information, where the radio access network node information includes at least one of a node identifier, node address, and/or node certificate associated with the radio access network node. In yet another example, the first service registration request may include service network information.

The method may further include securing the first service registration request if a pre-existing secure connection with the first service network node is available.

A radio access network (RAN) node is provided, comprising a communication interface and a processing circuit. The communication interface may serve to communicate with client devices. The processing circuit may be configured to: (a) receive a service registration request from a client device, (b) forward the service registration request to a connectivity network node serving the client device within the connectivity network, and/or (c) establish a secure connection with a service network node via the connectivity network node, wherein communications over the secure connection are secured against access by the connectivity network node.

A method operational at a service network node is also provided for establishing a secure connection with a radio access network (RAN) node. A control message may be received from a connectivity network node including a service registration request from a client device. A serving node identifier may be determined for a radio access network node from the control message. A secure connection with the radio access network node may be established via the connectivity network node, wherein communications over the secure connection are secured against access by the connectivity network node.

In one example, establishing the secure connection with the radio access network node may include: (a) determining, upon receipt of the control message, whether the service network node has a pre-existing secure connection with the radio access network node, (b) if the pre-existing secure connection is available, reusing the pre-existing secure connection with the radio access network node, and (c) if the pre-existing secure connection is not available, establishing the secure connection with the radio access network node via the connectivity network node.

In another example, establishing the secure connection with the radio access network node may include receiving a secure connection request from the connectivity network node which originated from the radio access network node.

The method may further include: (a) performing authentication and key agreement with the client device and deriving one or more security keys for the client device based on an authentication session key; and/or (b) sending a first security key for the client device over the secure connection with the radio access network node via the connectivity network node. The derived one or more security keys may include at least one for access stratum (AS) security and one for non-access stratum (NAS) security. The first security key may serve to secure access stratum communications.

A service network node is also provided, comprising a network communication interface and a processing circuit. The network communication interface may serve to communicate over a communication network. The processing circuit may be configured to: (a) receive a control message from a connectivity network node including a service registration request from a client device, (b) determine a serving node identifier for a radio access network node from the control message, and (c) establish a secure connection with the radio access network node via the connectivity network node, wherein communications over the secure connection are secured against access by the connectivity network node.

### BRIEF DESCRIPTION OF THE DRAWINGS

FIG. 1 illustrates a single radio link between a client device and a radio assess network (RAN) may serve to couple the client device to two or more networks while supporting multiple service connections associated with separate and distinct connectivity contexts and service contexts.

FIG. 2 illustrates a first exemplary attachment process in which service contexts, independent and separate from a connectivity context, is used to secure an interface between a radio access network and a service network node.

FIG. 3 illustrates a second exemplary attachment process in which service contexts, independent and separate from a connectivity context, is used to secure an interface between a radio access network and a service network node.

FIG. 4 illustrates exemplary security relationships between protocol layers of an access node, connectivity network node, and a service network node.

FIG. 5 illustrates a method operational at a radio access network (RAN) node for establishing a secure interface/connection with a service network node.

FIG. 6 is a block diagram illustrating an exemplary radio access network (RAN) node configured to establish a secure interface/connection with a service network node.

FIG. 7 illustrates a method operational at a service network node for establishing a secure interface/connection with a radio access network node.

FIG. 8 is a block diagram illustrating an exemplary service network node configured to establish a secure interface/connection with a radio access network node.

### DETAILED DESCRIPTION

In the following description, specific details are given to provide a thorough understanding of the aspects described herein. However, it will be understood by one of ordinary skill in the art that the aspects may be practiced without these specific details. For example, circuits may be shown in block diagrams in order avoid obscuring aspects in unnecessary detail. In other instances, well-known circuits, structures, and techniques may not be shown in detail in order not to obscure the aspects more fully described herein.

The word “exemplary” is used herein to mean “serving as an example, instance, or illustration.” Any implementation or aspect described herein as “exemplary” is not necessarily to be construed as preferred or advantageous over other implementations or aspects. The term “aspect” does not require that all aspects include the discussed aspect, or any discussed feature, advantage, and/or mode of operation. For ease of discussion and illustration, the terminology used herein may appear to address LTE; however, the aspects described herein are not intended to be limited to LTE. The aspects described herein are applicable to LTE and beyond LTE, for example 5G. The aspects described herein may also be applicable to networks developed prior to LTE, such as 4G or Wi-Fi. In fact, the aspects described herein may be employed in today's systems, i.e., systems implemented before standardization of 5G. For example, aspects described herein may be introduced as an addendum to the standards of 4G, LTE, and/or LTE-A networks. Accordingly, all references made to terms that may be associated with 3G, 4G, and/or LTE-A are made only for illustrative purposes and are not intended to limit the scope of any aspect presented herein.

3G systems supported a single subscription/single credential that covered one connection in each of the packet switched and circuit switched domains. The 3G systems supported an ability to register for the two domains in a single procedure. According to that procedure, an uplink dedicated control channel (UL DCCH) message was used to carry registrations for the packet switched and the circuit switched domain networks. A serving general packet radio service (GPRS) support node (SGSN) in the packet switched domain would update the mobile switching center (MSC) on the circuit switched domain. In this way, 3G systems allowed for communication in two distinct domains using one subscription. Even so, within each given domain there existed only a single connectivity context. In other words, a 3G system, under one subscription, would use one credential to provide a device with one connectivity context in each of the circuit switched and packet switched domains.

From a security point of view, identifying security parameters for a context of a single device in a 3G system could be relatively uncomplicated. For example, in 3G the signal radio bearer 2 (SRB2) was secured with the security keys of the latest context that was created. This made it straightforward to know which security context to apply to the SRB2. There were no provisions for multiple security contexts for a single physical device in a single domain, at least because only one security context was needed.

In LTE, each client device (e.g., user equipment or UE) includes a universal subscriber identity module (USIM) card that includes identification information and a key unique to that USIM card. A client device making use of a subscription to a service provided by a network operator is able to establish a radio link with the network by virtue of the identification and key information stored on the USIM card. In other words, there is presently a tight connection (e.g., a one-to-one relationship) between the use of an access link (e.g., for user plane and Radio Resource Control (RRC) or Media Access Control (MAC) signaling connections in case of cellular) and the connectivity context (e.g., EMM-EPS Mobility Management—and ESM-EPS Session Management—in case of LTE). Furthermore, when a client device connects with a network, in the example of LTE, a mobility management context and a session management context are created in a mobility management entity (MME), and both contexts are associated with the radio link. There is a one-to-one association between the pair of contexts and the radio link. Accordingly, it may be said that the pair of related contexts are tightly coupled to the radio link.

Presently, specific services may be delivered and controlled by dedicated functionality in a core network (CN). For example, a model may be considered where for a set of a given type of device (e.g., machine-to-machine (M2M) devices), dedicated mobility management entities (MMEs) are provisioned in the network, and the MME selection in an access node (e.g., eNB) considers the type of device in selecting the MME. In other words, if certain MMEs are dedicated for M2M traffic, then each access node will know to connect a device to one and only one MME that is dedicated to M2M traffic in connection with M2M device attachment to a network. It is not possible today, however, to simultaneously connect one physical client device to multiple MMEs, let alone multiple dedicated MMEs.

Current authentication and/or security models do not support separate authentication/security contexts for RANs and CNs relative to service providers.

### Overview

A first aspect provides for using a connectivity context to authenticate and secure signaling between a user device and a connectivity provider. A separate and distinct service context is used to authenticate and secure signaling between the user device and a service provider. A connectivity context for a client device may serve to setup an initial network connection with a connectivity provider (e.g., over a Radio Access Network). Then one or more services, e.g., each with a distinct service context, may be setup over the network connection. A service context may be separate and/or independent from the connectivity context (e.g., separate and/or independent security/authentication key hierarchies).

A second aspect provides for a secure interface/connection to be established between a service network node and a radio access network node via a connectivity network node, but communications via such secure interface/connection may be secured against access by the connectivity network node.

A third aspect provides for sending a security key from the service network node to the radio access network node via the secure interface/channel. The security key may be used to secure communications between the radio access network node and the user/client device.

Exemplary Network with Separate Service Context and Connectivity Context

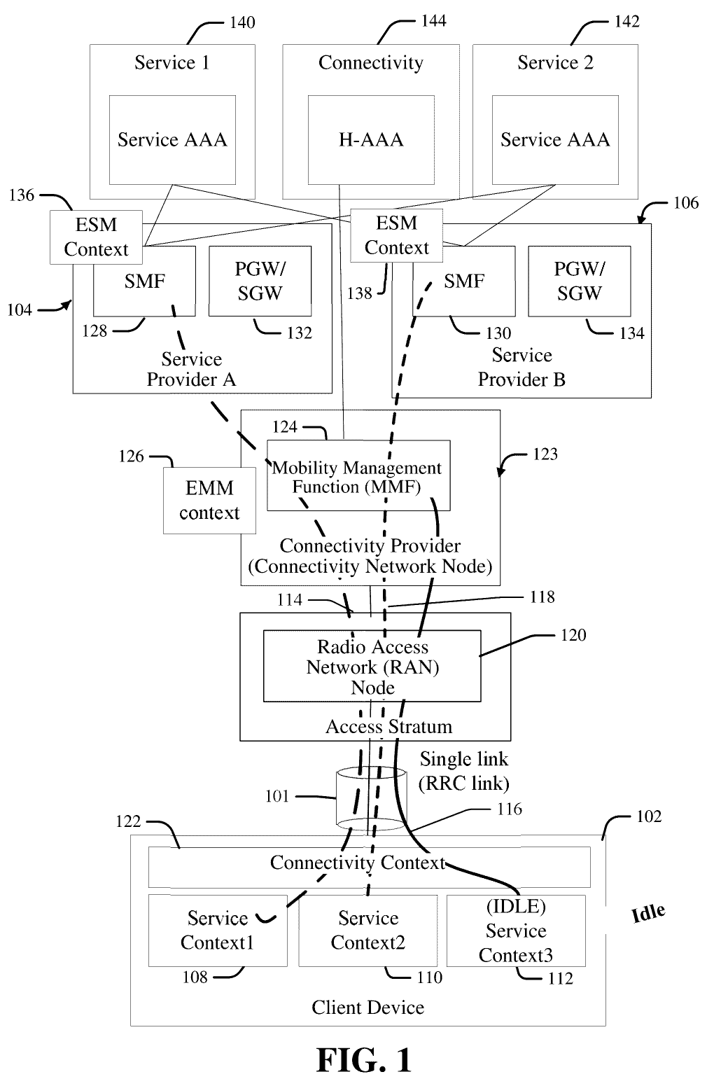

FIG. 1 illustrates a single radio link 101 between a client device 102 and a radio assess network (RAN) 120. The radio link 101 may serve to couple the client device 102 to two or more service providers networks or provisioning functionalities 104 and 106 while supporting multiple service connections 114, 116, 118 associated with different service contexts 108, 110, and 112. In this example, distinct contexts are used for connectivity authentication/security and service authentication/security (e.g., each of these contexts having distinct and separate/independent key hierarchies).

For instance, an EMM context 126 may maintain a security context established based on connectivity credentials to allow the client device 102 and a Mobility Management Function 124, acting as a Common Control Plane Function, to securely communicate with each other. This EMM context 126 may serve to secure signaling between the client device 102 and the MMF 124 across the RAN 120. One or more ESM contexts 136, 138 (i.e., service contexts) may be established with one or more Service Management Functions (SMFs) 128, 130 under the control of the service providers. The ESM contexts may be established through the connectivity provider MMF 124. The client device 102 and service provider SMFs 128 and 130 authenticate each other based on service credentials. In alternative implementations, the client device 102 may be able to establish its ESM contexts based on its connectivity credentials.

As used herein the term “client device” may be used to broadly refer to a user equipment (UE), mobile device, communication device, smart phone, wireless device, an appliance etc. Similarly, the terms “radio access network node” and “access node” may be interchangeably used to refer to any device providing network connectivity to client devices and may include, for instance, an eNB or eNodeB, an NB or NodeB, an gNB or gNodeB, and/or an access point. The terms “connectivity network node” may refer to any device or functionality under control of a connectivity provider (e.g., a control-plane core network entity) that facilitates connectivity to a network and may include, for instance, a mobility management entity (MME), Mobility Management Function (MMF), Common Control Plane Function (CCPF), etc. The term “service network node” may refer to a device (e.g., a service control-plane core network entity) or functionality (e.g., a control-plane session management function and/or a control-plane mobility management function) that facilitates services to client devices and may include a Session Management Function (SMF), etc. When multiple SMFs are in use, an MMF may act as the common control plane function (CCPF) supporting the various SMFs.

A single connectivity context 122, implemented by the client device 102, may serve to establish a radio link 101 that is shared by multiple simultaneously service contexts 108, 110, and 112. The single connectivity context 122 (e.g., EMM context) is used with a network mobility management function (MMF) 124 that provides: connectivity-level security, signaling for data bearer management and data connection management, paging, mobility, etc. The use of the single connectivity context 122 facilitates use of the multiple simultaneous service contexts 108, 110, 112, having corresponding service connections 114, 116, and 118, over the same radio link 101. For example, if the client device 102 has three types of subscriptions (e.g., service contexts), this may enable an ability to provide three simultaneous service connections 114, 116, and 118, one for each subscription and/or service context 108, 110, and 112, over the single (same) radio link 101 (e.g., using a single radio bearer), from the client device 102. As illustrated, any one or more of the service connections 114, 116, and/or 118 may be idle or active at any given time.

The MMF 124 may be implemented logically close to the RAN 120 and serves to manage the establishment of the connectivity context (e.g. EMM context) and to establish the radio link 101 based on the shared connectivity context 122.

The host MME 124 may perform non-access stratum (NAS) evolved packet system (EPS) Mobility Management (EMM) over a control plane with the client device 102 to control mobility and/or security for the client device 102. The host MME 124 may authenticate a client device 102 with a home authorization, authentication, and accounting (H-AAA) server 144 to ascertain whether the connectivity context 122 should be established, based on credentials and subscription information associated with the client device 102. The connectivity context 122 serves to establish a single radio link 101 that can be shared by multiple service contexts 108, 110, and 112 of the client device 102.

In one example, the traditional non-access stratum (NAS) model is modified to enable ESM contexts separate from the EMM context (i.e., EMM context in the Host MME 124 can be established without an ESM context). Credentials used to establish an EMM security (connectivity credentials) may be different from credentials used to establish an ESM context (service credentials). Each service provider 104 and/or 106 may perform non-access stratum (NAS) EPS Session Management (ESM) over a control plane with the client device 102 to support service provisioning for the service connection 118.

Once the connectivity context 122 is established, the client device 102 may establish additional ESM contexts corresponding to different sets of credentials with different network entities that allow service differentiation through service provisioning by differentiated session management functions (SMFs) over the connectivity provider 123.

In this example, the RAN 120 may be coupled to a single connectivity provider 123 that is coupled to a plurality of service providers 104 and 106. For example, each service provider 104, 106 may include a session management function (SMF) 128 and 130 as well as one or more Packet Data Network Gateway (PGW) and one or more Serving Gateway (SGW) 132 and 134. Each of these SMFs 128 and 130 may maintain ESM contexts 136 and 138 for service connections 114 and 118 established using the credential and subscription information of service contexts 108 and 110 stored by the client device 102. The SMFs 128 and 130 may establish the service contexts 108 and 110 (e.g., ESM context) for the client device 102 via service authorization, authentication, and accounting (Service AAA) servers 140 and 142 to ascertain whether the service connection 114 and/or 118 should be setup based on the credentials associated with services.

In the exemplary illustration of FIG. 1, the client device 102 may support a first Service Context 1 108, a second Service Context 2 110, and a third Service Context 3 112. However, it is contemplated that any number of service contexts may be supported by the client device 102 over a single radio link 101 established and secured using a single connectivity (EMM) context 126.

In FIG. 1, the multiple service contexts 108, 110, and 112 may be supported between the client device 102 and a network 104 and/or 106, where each service context 108, 110, and 112 may correspond to one or more sets of credentials. A set of service credentials may be defined as, or include, a set of information that enables other devices to identify the client device 102 (or user/subscriber of the client device) to a service, security keys used for authentication, etc. Note that the set of service credentials that may be part of each service context may be separate, distinct, and/or independent from any connectivity credentials that may be part of a connectivity context. In this example, a first service context 108 and a second service context 110 may be used or associated with active service connections 114 and 118 for different services while a third service context 112 may have an idle connection 116 that may have been previously established but is currently unused. The idle connection 116 may be subsequently reactivated when a service is reestablished or is newly established.

In one example, the connections 114, 116, and 118 for the multiple simultaneous service contexts 108, 110, and 112 may be multiplexed over a single Layer 2 connection of a communication protocol stack (e.g., LTE Layer 2, RRC layer, WI-FI, etc.). The service contexts 108, 110, and 112 may be distinguished based on specific/distinct identities used by the client device 102 for each service context 108, 110, and 112. The client device 102 is provisioned with a set of connectivity credentials (EMM context or connectivity context) that provides authentication and security access for connectivity establishment with the Host MME (i.e. at least EMM context) to facilitate signaling with the network.

Service-related credentials may be used to establish the one or more ESM context(s) (e.g., service contexts) with an SMF (Service Management Function). In various configurations, the SMFs 128 and 130 may be operated and/or controlled by a service provider and are physically separate from the MMF 124 which is controlled by the connectivity provider 123.

### Exemplary Non-Access Stratum (NAS) Security

In one aspect, the typical non-access stratum (NAS) model may be modified to enable separate EMM and ESM (i.e., EMM context with MMF can be established without an ESM context). Credentials used to establish EMM context (connectivity credentials) may be different from credentials used for ESM context (service credentials). In one example, separate and independent key hierarchies may be used and/or maintained by the EMM context and ESM contexts.

Once the connectivity context 122 is established, the client device 102 may establish one or more ESM contexts with different network entities based on the corresponding sets of credentials, which allow service differentiation by differentiated connection management entities in the connectivity provider(s). As an example, the service provider may maintain and control the Service Management Function (SMF).

In the example of FIG. 1, the RAN 120 may be coupled to a plurality of service providers 104 and 106. For example, the service providers 104, 106 may operate over a single connectivity provider 123 and each service provider may include a session management function (SMF) as well as one or more Packet Data Network Gateways (PGW) and one or more Serving Gateways (SGW). Each of these SMFs 128 and 130 may maintain respective ESM contexts 136 and 138 for service connections 114 and 118 established using the credential and subscription information that may be supplied by the corresponding Service AAA (authorization, authentication, and accounting). For example, the SMFs 128 and 130 may authenticate the device 102 via or supported by respective service authorization, authentication, and accounting (Service AAA) servers 140 and 142. The SMFs 128 and 130 may ascertain whether the service connection 114 and/or 118 should be setup based on the credentials associated with the service contexts 108 and 110 and provided by service providers 104 and 106. Successful authentication enables the SMFs to establish service contexts 108 and 110 (e.g., ESM contexts) for the client device 102.

In the exemplary illustration of FIG. 1, the client device 102 may establish a first Service Context 108, a second Service Context 110, and a third Service Context 112. However, it is contemplated that any number of service contexts may be established by the client device 102.

In FIG. 1, the multiple service contexts 108, 110, and 112 may be established by the client device 102 and multiple service providers 104 and/or 106, where each service context 108, 110, and 112 may correspond to one or more sets of service credentials. A set of credentials may be defined as, or include, a set of information that enables other devices to identify the client device 102 (or user/subscriber of the client device) to a service, security keys used for authentication, etc. A credential may be implemented as a security context.

In one example, the connections 114, 116, and 118 based on the multiple simultaneous service contexts 108, 110, and 112 may be multiplexed over a single Layer 2 connection of a communication protocol stack (e.g., LTE Layer 2). The service contexts 108, 110, and 112 are distinguished based on specific/distinct identities used by the client device 102 for each service context 108, 110, and 112 and/or each service provider associated therewith.

The client device 102 may also be provisioned with a set of connectivity credentials that are used to facilitate secure connection establishment with the Host MME (i.e. at least an EMM context) that provides a signaling or connection to the network and enables mobility management. Such credentials can be, for instance, out-of-the-box credentials, operator credentials, or credentials provided by an OEM and installed in the client device 102 at manufacturing by an entity manufacturing the client device 102. The use of OEM credentials enables an OEM to provide the credentials and host the authentication for such credentials, thus enabling the client device 102 to support different service providers since service provider credentials are used to provide ESM context only. With the use of OEM credentials for establishment of the first (EMM) context (e.g., connectivity context), it is possible to establish just an EMM (connectivity) context that provides signaling, security, etc. without any charging for establishing, since no data traffic or messages is generated in relation to this context.

### Exemplary Access Stratum (AS) Security

The access stratum (AS) is a set of protocols between a client device 102 and a RAN 120 that handle activities between a client device 102 and a core network (CN). In the example of FIG. 1, the core network (CN) may include the MMF 124 but the one or more SMF(s), one or more SGW, and one or more PGW are now controlled by, operated by, and/or part of each service provider. In the AS, multiple radio access bearers (RABs) may be established between the core network (CN) and the client device 102. In one aspect of the disclosure, each RAB may be associated with a different ESM context, and each ESM context may be determined by a virtual ESM (VESM) tag (or identifier). In one aspect of the disclosure, multiple RABs are associated with the same EMM context. In this case, the RAN 120 (e.g., eNode B) has no visibility of the multiple ESM contexts. The RAN 120 has a set of RABs, some corresponding to for example a first ESM, some to a second ESM, and the MMF 124 has a mapping of the RABs to specific ESM contexts.

In FIG. 1, the RAN 120 is depicted as existing within an access stratum. Among the services provided by the access stratum is the transport of NAS messages between NAS entities (e.g., client devices and core network nodes). NAS protocols apply between a client device, such as the client device 102, and a core network (CN), such as a CN of service provider A and/or a CN of service provider B depicted in FIG. 1. The access stratum transports NAS signaling. NAS signaling is not terminated at the access stratum. The single RRC link 101 between the client device 102 and the RAN 120 may be split logically into multiple service connections, for example, service connections 114 and 116. The service connections are established in association with the corresponding service contexts (ESM contexts).

### Exemplary Attachment Procedures In Which Connectivity Node Selects Service Network Node

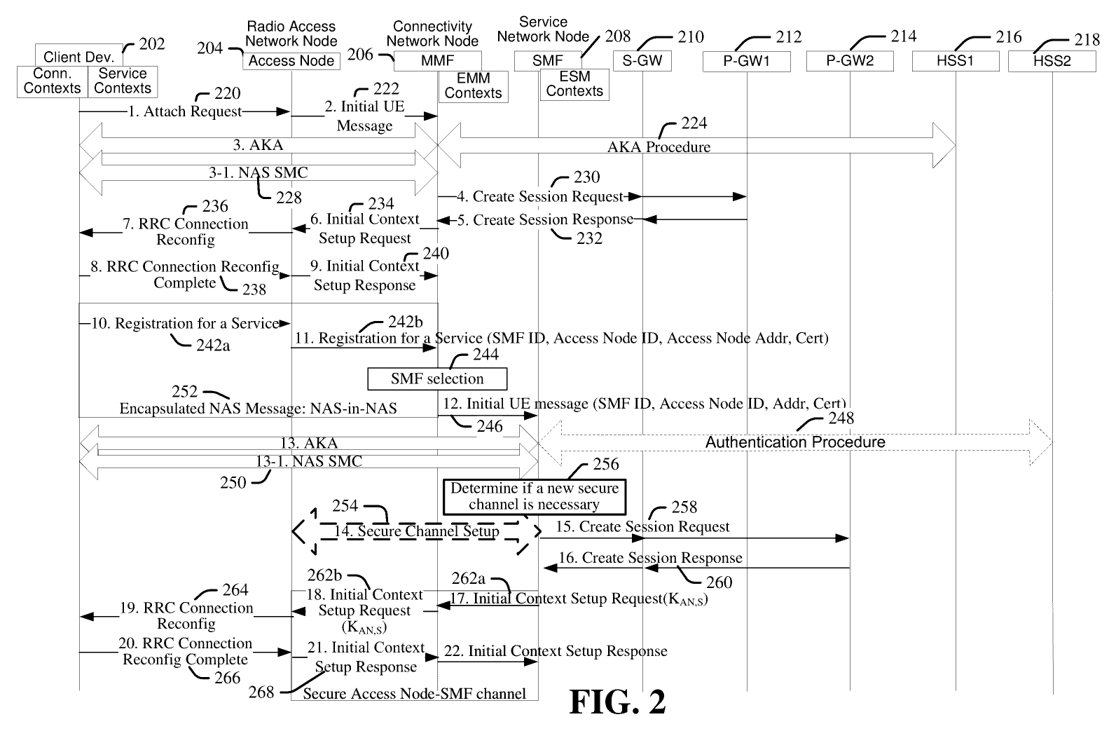

FIG. 2 is a call flow diagram illustrating a first process performed by a client device 202, an access node 204, an MMF 206, an SMF 208, a service gateway (S-GW) 210, a first packet data gateway (P-GW) 212, a second P-GW 214, a first home subscriber server (HSS) 216, and a second HSS 218, to establish a radio link or connection using a connectivity context (e.g., EMM context) at the client device 202. As used herein, a “home subscriber server” or “HSS” may refer to a device or function that includes a subscriber database of profile information for users of client devices and security information (e.g., credentials) for the users of the client devices. The radio link or connection may then be shared by a plurality of service contexts (e.g., SMF contexts). The client device 202, access node 204, MMF 206, SMF 208, S-GW 210, first P-GW 212, second P-GW 214, first home HSS 216, and second HSS 218, may be the same as those illustrated in any of FIG. 1. That is, the MMF 206 may be a connectivity network node, the SMF 208, service gateway (S-GW) 210, and the packet data gateways (P-GW) 212 and 214 may operate at the service network.

Attachment to the connectivity network is performed (e.g., using a connectivity context for the client device) to establish a network connection and then one or more services may be established over the network connection. A secure interface may be established between a radio access network node (RAN), e.g., an access node, and a service network node (e.g., ESM).

The client device 202 attempts to attach to a connectivity network by sending an access stratum message (e.g., an RRC message) that includes a NAS mobility management message (e.g., an Attach Request 220, a Tracking Area Update, or a Service Request) to the access node 204, which sends the message to the MMF 206 in an Initial UE Message 222. The message 222 may include a client device ID such that the MMF 206 may identify the client device 202.

The MMF 206 may check whether the client device 202 is permitted to attach or not by performing an Evolved Packet System (EPS) Authentication and Key Agreement (AKA) procedure 224 with the first HSS 216. For example, the first HSS 216 may derive an MME base key by generating authentication vectors and sending them to the MMF 206. The MMF 206 then performs authentication with the client device, on behalf of the HSS1 216. Then the MMF 206 performs an NAS security setup procedure with the client device 202 by exchanging NAS Security Mode Command (SMC) messages. NAS messages 228 between the client device 202 and MMF 206 may be encrypted and integrity protected, for example, based on the security context (if established) stored in the MMF 206 if NAS SMC is completed.

Next, the MMF 206 selects an S-GW 210 based on S-GW selection function and allocates an EPS Bearer Identity for the default bearer for the client device 202. Then, the MMF 206 sends a Create Session Request 230 to the S-GW 210. In response, the S-GW 210 creates a new entry in its EPS Bearer table and sends a Create Session Request message 230 to the first P-GW1 212.

In response to the Create Session Request message 230, the first P-GW1 212 may create a new entry in its EPS Bearer table and generate a Charging ID. Then the first P-GW1 212 sends a Create Session Response message 232 to the S-GW 210 which forwards it to the MMF 206. Next, the MMF 206 provides the access node 204 with an Initial Context Setup Request message 234 that contains an Attach Accept message. Next, the access node 204 sends an RRC Connection Reconfiguration message 236 to the client device 202, including the EPS Radio Bearer Identity and Attach Accept message.

In response, the client device 202 sends an RRC Connection Reconfiguration Complete message 238 to the access node 204. Next, the access node 204 sends an Initial Context Setup Response message 240 to the MMF 206.

Utilizing the above-described process, the client device 202 can establish an EMM context or connectivity context with the MMF 206. After the EMM context is established, the client device 202 may establish one or more SMF contexts or service contexts using the following described process.

In order to establish an ESM context for a service or service connection, the client device 202 sends a Service Registration message 242a including a service identifier (service ID) to the access node 204. The access node 204 forwards the Service Registration message 242b (Step 11) to the MMF 206 and includes the access node identifier, the access node address, and optionally an access node certificate. The Service Registration message 242 may be, for instance, a NAS Session Management message (e.g., a Session Establishment Request message). Upon receipt of the Service Registration message 242, the MMF 206 (connectivity network node) determines or selects 244 an SMF 208 (service network node) based on the service ID provided by the client device 202 and sends an Initial UE Message 246 to the SMF 208 providing also the access node identifier (ID), the access node address, and optionally an access node certificate. The MMF 206 may also determine or preselect 244 an SME 208 based on preconfigured information in the MMF 206 or based on the client device 202 subscription profile when the client 202 establishes an EMM context or connectivity context with the MMF 206. The message 246 may include a client device identifier such that the SMF 208 may identify the client device 202.

The SMF 208 may check whether the client device 202 has a subscription of service by performing an authentication procedure 248 (e.g., an EPS-AKA procedure or EAP-based authentication procedure) with the second HSS2 218. For example, the second HSS2 218 may derive a key by generating authentication vectors and sending them to the SMF 208. The SMF 208 may then perform authentication with the client device 202 (AKA procedure in Step 13), on behalf of the second HSS2 218. Then the SMF 208 may perform a security setup procedure 250 (e.g. a NAS security setup procedure) with the client device 202 by exchanging messages for the establishment of a security association between the UE 202 and the SME 208 (e.g. NAS Security Mode Command (SMC) messages).

The NAS messages 250 between the client device 202 and the SMF 208 may be protected based on the security association established via the security setup procedure 250 using ESM security contexts. For example, the client device 202 may encrypt and protect a NAS message using an ESM security context of the SMF 208. The NAS message for the SMF may be encapsulated in an outer NAS message (NAS-in-NAS 252) for the MMF 206. The outer NAS message is encrypted and integrity protected using the security context established between the client device 202 and the MMF 206. The outer NAS message may include (1) an SMF ID to enable the MMF to identify the SMF 208 to which the inner NAS message is forwarded and (2) a UE ID (which is assigned by SMF) to enable the SMF 208 to identify the client device 202. In one example, the UE ID may include a GUTI or GUTSI (or other suitable identifiers) that has been allocated by SMF previously.

Similarly, the SMF 208 (hosted by the service provider) may encrypt and protect an NAS message using an ESM security context. Then the NAS message is encapsulated in an outer NAS message (or any other suitable container that may be defined) for the MMF 206. In one example, the outer NAS message may not be protected, but transported to the MMF 206 via a secure channel. In one example, the MMF 206 and SMF 208 may establish an IP Security (IPsec) channel for secured communication. The outer NAS message may include the UE ID to enable the MMF 206 to map the UE ID to an S1-AP UE ID. In another example, the outer NAS message may be encrypted and integrity protected using the EMM security context of the MMF 206.

In this example, the SMF 208 (service network node) may determine 256 whether a secure channel/connection is already available with the access node 204 (radio access network node), based on one or more of the access node identifier (ID), the access node address, and/or the access node certificate. For instance, such secure channel may have been previously established (e.g., pre-existing) between the access node 204 and the SMF 208 (service network node). If there is an existing secure channel (e.g., secure connection or tunnel), the SMF 208 may indicate, either explicitly or implicitly, a secure channel identifier when it responds to the access node 204 (e.g., as part of initial context setup message—Step #18). Otherwise, if no secure channel with the access node 204 is available, the SMF 208 may initiate a Secure Channel Setup 254 (e.g., by providing its information such as IP address, SMF ID, Certificate, etc.) to the access node 204. This determination allows either reusing a pre-existing secure channel/connection or setting up a new secure channel/connection with the access node 204.

Then, the SMF 208 sends a Create Session Request 258 to the S-GW 210 (hosted by the service provider). In response, the S-GW 210 creates a new entry in its EPS Bearer table and sends a Create Session Request message 258 to the second P-GW2 214. In response to the Create Session Request message 258, the second P-GW 214 may create a new entry in its EPS Bearer table and generate a Charging ID. Then the second P-GW2 214 sends a Create Session Response message 260 to the S-GW 210, which then forwards it to SMF 208.

Next, the SMF 208 obtains (e.g., generates, retrieves, and/or receives) one or more security keys (e.g., to secure communications to/from the client device, such as K_{AN,S} and K_{UP-GW,S}) and securely send them to the access node 204 as part of an Initial Context Setup Request message 262a/262b that may also include an Attach Accept message, via the MMF 206 (connectivity network node). The MMF 206 forwards the Initial Context Setup Request message 2626b to the access node 204. In one example, the one or more security keys may include an access node-service network node security key K_{AN,S} that may be used to protect over the air (or access stratum) messages between the client device 202 and access node 204. In another example, the one or more security keys may also include a user-plane security key K_{UP-GW,S} that may be used to protect the user-plane messages between the client device 202 and the user-plane gateway for the service (i.e., UP-GW,S) when the user-plane gateway is collocated with the access node 204.

Next, the access node 204 sends an RRC Connection Reconfiguration message 264 to the client device 202, including the EPS Radio Bearer Identity and Attach Accept message. In response, the client device 202 sends an RRC Connection Reconfiguration Complete message 266 to the access node 204. Next, the access node 204 sends an Initial Setup Context Response message 268 to the MMF 206, which forwards the Initial Setup Context Response message 268 to the SMF 208. In this manner, the access node 204 is provided with at least one security key (e.g., K_{AN,S}) that may be used to secure communications between the access node 204 and the client device 202. Note that because the one or more security keys (e.g., K_{AN,S} or K_{UP-GW,S}) is sent from the SMF 208 to the access node 204 via a secure channel/connection 254, the intermediate MMF 206 cannot access or obtain the security key K_{AN,S}.

In one example, an AS Security Mode Command (SMC) may be used to establish a security context between the client device 202 and access node 204. For instance, the security key K_{AN,S} may be part of an AS security context. Based on the AS security context, the client device 202 and access node 204 can protect the over-the-air traffic using or based on the security key K_{AN,S}, which may serve to derive a cryptographic key or otherwise may be used to secure the over-the-air-traffic. Although a single radio link (e.g., single link 101 in FIG. 1) may be used for multiple service connections, each service connection can be protected with a separate key based on the corresponding AS security context and distinguished by the corresponding VESM tag. A virtual EPS Session Management (VESM) tag may be associated with or mapped to one or more radio bearers.

Utilizing the above-described process, the client device 202 can establish one or more ESM contexts with the SMF(s) (e.g., SMF 208). For example, this process may be used in the first HMME control plane model illustrated in FIG. 2.

### Exemplary Attachment Procedures In Which Radio Access Network Node Selects Service Network Node

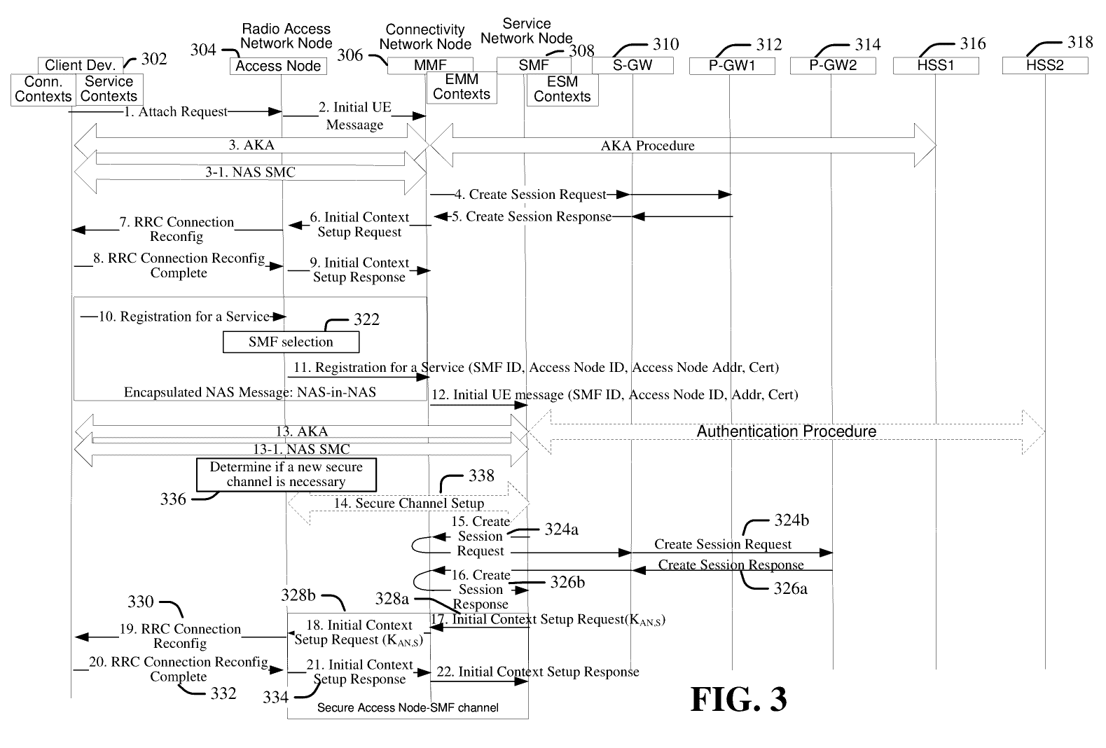

FIG. 3 is a flow diagram illustrating an exemplary signaling process 300 performed by a client device 302, an access node 304, an MMF 306, an SMF 308, a service gateway (S-GW) 310, a first packet data gateway (P-GW) 312, a second P-GW 314, a first home subscriber server (HSS) 316, and a second HSS 318, to establish a radio link or connection using a single connectivity context (e.g., EMM context) at the client device 302, which is then shared for a plurality of service contexts (e.g., SMF contexts) or service connections.

The signaling process illustrated in FIG. 3 is substantially similar to the signaling process of FIG. 2. Therefore, only their relevant differences will be discussed below. However, in this implementation, it is the access node 304 that selects 322 the SMF 308 (service network node).

After the EMM context or connectivity is established, the client device 302 may establish one or more SMF contexts using the following described process. For example, the SMF 308 sends a Create Session Request 324a to the S-GW 310 via the MMF 306. In response, the S-GW 310 creates a new entry in its EPS Bearer table and sends a Create Session Request message 324b to the second P-GW2 314. In response to the Create Session Request message 324b, the second P-GW2 314 may create a new entry in its EPS Bearer table and generate a Charging identifier (ID). Then the second P-GW2 314 sends a Create Session Response message 326a to the S-GW 310, which forwards the message 326b to the SMF 308 via the MMF 306.

Next, the MMF 306 sends an Initial Context Setup Request message 328a/328b to the access node 304. The SMF 308 may obtain (e.g., generate, obtain, receive, or retrieve) one or more security keys (e.g., K_{AN,S} or K_{UP-GW,S}) and securely sends them to the access node 304, via the MMF 306 (connectivity network node) as part of an Initial Context Setup Request message 328a/328b that may also include an Attach Accept message. The MMF 306 forwards the Initial Context Setup Request message 328b to the access node 304. In one example, the one or more security keys may include an access node-service network node security key K_{AN,S} that may be used to protect over the air (or access stratum) messages between the client device 302 and access node 304. In another example, the one or more security keys may also include a user-plane security key K_{UP-GW,S} that may be used to protect the user-plane messages between the client device 302 and the user-plane gateway for the service (i.e., UP-GW,S) when the user-plane gateway is collocated with the access node 304.

Next, the access node 304 sends an RRC Connection Reconfiguration message 330 to the client device 302, including the EPS Radio Bearer Identity and Attach Accept message. In response, the client device 302 sends an RRC Connection Reconfiguration Complete message 332 to the access node 304. Next, the access node 304 sends an Initial Context Setup Response message 334 to the MMF 306, which forwards the Initial Setup Context Response message 334 to the SMF 308. Utilizing the above-described process, the client device 302 can establish one or more ESM contexts or service connections with the SMF(s) (e.g., SMF 308). In this manner, the access node 304 is provided with a security key K_{AN,S} that may be used for securing communications between the access node 304 and the client device 302. Note that because the security key K_{AN,S} is sent from the SMF 308 to the access node 304 via the secure channel/connection 338, the intermediate MMF 306 cannot access or obtain the security key K_{AN,S}.

In this example, the access node 304 may determine 336 whether a secure channel/connection is already available with the SMF 308 (service network node). For instance, such secure channel may have been previously established (e.g., pre-existing) between the access node 304 and the SMF 308 (service network node). If there is an existing secure channel (e.g., secure connection or tunnel), the access node 304 may use it to communicate with the SMF 308 (service network node). Otherwise, if no secure channel/connection with the SMF 308 is available, the access node 304 may initiate a Secure Channel Setup 338 (e.g., by providing its information such as IP address, Client Device ID, Certificate, etc.) to the SMF 308. This permits either reusing a pre-existing secure channel/connection or setting up a new secure channel/connection with the SMF 308.

In this example, the SMF 308 (service network node) may determine whether a secure channel/connection is already available with the access node 304 (radio access network node), based on one or more of the access node ID, the access node address and the access node certificate. For instance, such secure channel may have been previously established (e.g., pre-existing) between the access node 304 (radio access network node) and the SMF 308 (service network node). If there is an existing secure channel (e.g., secure connection or tunnel), the SMF 308 may indicate, either explicitly or implicitly, a secure channel identifier when it responds to the access node 304 (e.g., as part of initial context setup message—Step 18). Otherwise, if no secure channel with the access node 304 is available, the SMF 308 may initiate a Secure Channel Setup 338 (e.g., by providing its information such as IP address, SMF ID, Certificate, etc.) to the access node 304. This permits either reusing a pre-existing secure channel/connection or setting up a new secure channel/connection with the access node 304 (radio access network node).

In some implementations, different service registrations for the same client device 202 or 302 may establish different secure connections (e.g., different secure access node-SMF channels) with one or more SMFs (service network nodes). The different secure connections are secured (e.g., by different security keys (e.g., K_{AN,S1}, K_{AN,S2}, . . . K_{AN,Sn})) against access by the MMF 206 or 306 (connectivity network node).

For instance, the access node 204 or 304 (RAN node) may receive a first service registration request from the client device 202 or 302 and forward the first service registration request to the MMF 206 or 306 (e.g., a connectivity network node) within a connectivity network. A first secure connection is then established with the SMF 208 or 308 (e.g., a first service network node) via the MMF 206 or 306 (e.g., connectivity network node), wherein communications over the first secure connection are secured against access by the MMF 206 or 306 (e.g., connectivity network node). Subsequently, a second service registration request may be received by the access node 204 or 304 from the client device 202 or 302 and may be forwarded to the MMF (e.g., connectivity network node). A second secure connection may be established with a second SMF (e.g., second service network node) via the MMF 206 or 306 (e.g., connectivity network node), wherein communications over the second secure connection are secured against access by the MMF 206 or 306 (e.g., connectivity network node).

It may also be observed that FIGS. 2 and 3 illustrate different/alternative options for routing messaging (e.g., Create Session Request—step 15 and Create Session Response—step 16). While FIG. 2 illustrates that the SMF 208 may route these messages, FIG. 3 illustrates that these messages may instead be routed via the MMF 306. Either of these alternative routing aspects may be implemented in FIGS. 2 and/or 3.

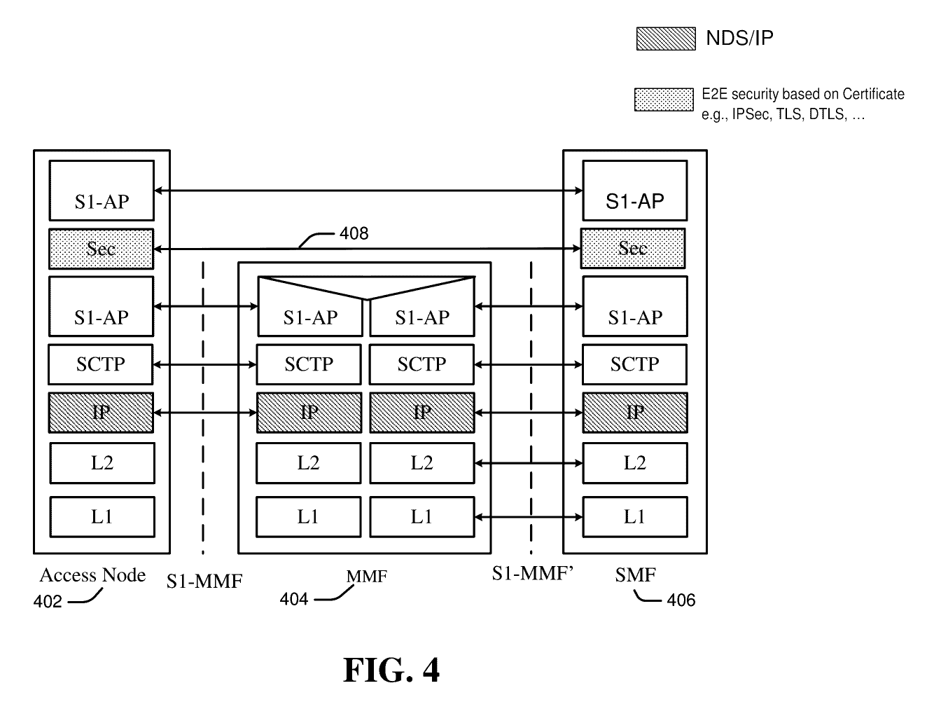

FIG. 4 illustrates exemplary security relationships between protocol layers of a RAN node (e.g., access node), connectivity network node (e.g., MMF), and a service network node (e.g., SMF). The signaling between the access node 402 and the MMF 404 or SMF 406 may use the S1AP (S1 Application Protocol). An example of S1AP is defined in 3GPP TS 36.413—Evolved Universal Terrestrial Radio Access Network (E-UTRAN); S1 Application Protocol (S1AP), Release 12. S1AP messages may be protected using NDS/IP (Network Domain Security/Internet Protocol). NDS/IP utilizes IP Security (IPSec) to implement security domain services. This example illustrates that a separate and distinct secure interface 408 is setup between the RAN node (access node) and the service network node (SMF) which is independent and secure from the connectivity provider (e.g., connectivity network node, MMF 404). For instance, an IPSec tunnel may be used to protect the messages between the access node 402 and the SMF 406 independent of any other protection that may exist between the access node 402 and MMF 404 and/or between the MMF 404 and SMF 406. Alternatively, a transport layer security (TLS) connection may be used to protect the signaling between the access node 402 and the SMF 406.

### Exemplary Radio Access Network Node and Operation Therein To Establish Secure Connection With Service Network Node

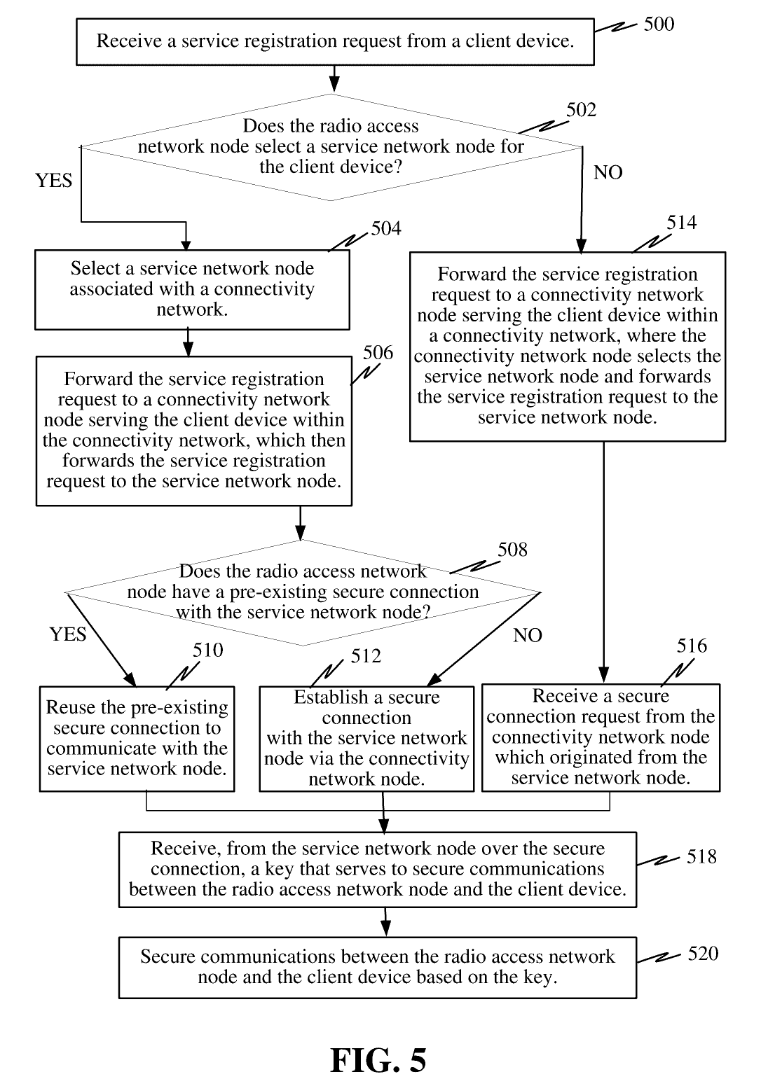

FIG. 5 illustrates a method operational at a radio access network (RAN) node for establishing a secure interface/connection with a service network node. A service registration request is received from a client device in an access stratum message 500. A service network associated with a connectivity network may be determined, wherein the service network node operates within the service network 502. The RAN may determine the service network based on an indication received from the client device in the access stratum message containing the service registration request. The service registration request is forwarded to the connectivity network node serving the client device 504, possibly including an access node identifier, an access node address, and/or an access node certificate. The service registration request is forwarded by the connectivity network node to the service network node serving the client device including the access node identifier, the access node address, and/or the access node certificate. A secure connection may be established between the radio access network and a service network node serving the service network, triggered by either the RAN node or the service node, wherein communications over the secure connection are secured against access by the connectivity network node 506.

Establishing the secure connection may be done in different ways depending on whether the radio access network node selects the service network node 508, as described, for example, in FIG. 3, or if the connectivity network node selects the service network node, as described in FIG. 2.

In a first example where the RAN node selects the service network node as described in FIG. 3, establishing the secure connection with the service network node includes determining by the radio access network whether the radio access network node has a pre-existing secure connection with the service network node 510. If the pre-existing secure connection is available, the radio access network node may reuse the pre-existing secure connection to communicate with the service network node 512. Otherwise, if the pre-existing secure connection is not available, the radio access network node may establish a secure connection with the service network node via the connectivity network node 514.

FIG. 5 illustrates a method operational at a radio access network (RAN) node for establishing a secure interface/connection with a service network node. A service registration request is received from a client device 500 in an access stratum message.

In a first implementation, the radio access network node may select the service network node for the client device 502. In such case, the RAN may select/determine the service network node (and/or an associated service network) associated with a connectivity network 504. Selection of the service network node may be based on, for example, an indication (e.g., a service network identifier or an SMF identifier) received from the client device in the access stratum message containing the service registration request (e.g., Step 242a in FIG. 2. or Step 10 in FIG. 3). The service registration request is forwarded, by the radio access network node, to a connectivity network node serving the client device within the connectivity network 506. The forwarded service registration request (e.g., Step 242b in FIG. 2. or Step 11 in FIG. 3) may include a radio access network node identifier, a radio access network node address, and/or a radio access network node certificate. Subsequently, the service registration request is forwarded (e.g., Step 246 in FIG. 2 or Step 12 in FIG. 3) by the connectivity network node to the selected service network node serving the client device. The forwarded service registration request (e.g., Step 242b in FIG. 2. or Step 11 in FIG. 3) may also include the access node identifier, the access node address and the access node certificate.

The radio access network node may ascertain whether it has a pre-existing secure connection with the service network node 508. If such pre-existing securing connection exists, the radio access network node may reuse the pre-existing secure connection to communicate with the service network node 510. The service registration request may be secured (while forwarded) if a pre-existing secure connection with the service network node is available. Otherwise, if a pre-existing secure connection does not exist, the radio access network node may establish a secure connection with the service network node via the connectivity network node 512. Communications between the radio access network node and the service network node over the secure connection (or pre-existing secure connection) are secured against access by the connectivity network node. The secure connection may be, for example, a tunnel between the radio access network node and the service network node.

In a second implementation, the radio access network node does not select the service network node for the client device 502. Instead, the service the service registration request is forwarded by the radio access network node to a connectivity network node serving the client device within a connectivity network, where the connectivity network node selects the service network node and forwards the service registration request to the service network node 514. The radio access network node may then receive a secure connection request from the connectivity network node which originated from the service network node 516.

The radio access network node may receive, from the service network node over the secure connection, a key that serves to secure communications between the radio access network node and the client device 518. Communications between the radio access network node and the client device may then be secured based on the key 520.

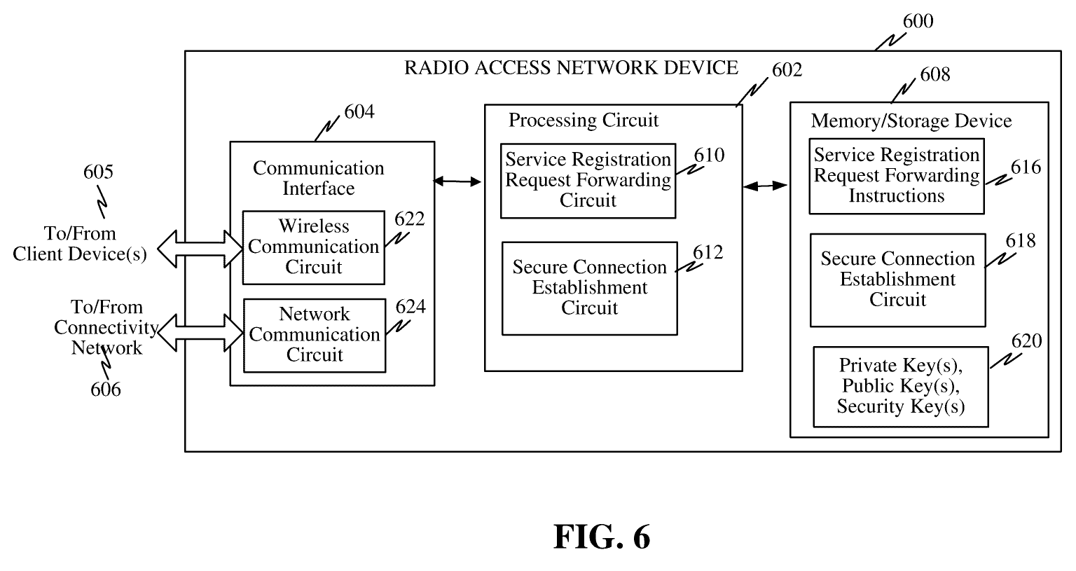

FIG. 6 is a block diagram illustrating an exemplary radio access network (RAN) node 600 configured to establish a secure interface/connection with a service network node. The RAN node 600 may be configured to perform one or more steps illustrated in FIGS. 2, 3, 4, and/or 5. The radio access network (RAN) node may comprise a communication interface 604, a processing circuit 602, and a memory/storage device 608. The communication interface 604 may include a wireless communication circuit 622 for communicating with client devices (e.g., over a wireless network) 605, and/or a network communication circuit 624 for communicating over a connectivity network 606.

The processing circuit 602 may be configured to receive a service registration request from a client device. A service registration request forwarding circuit 610 may be configured to forward the service registration request to a connectivity network node within the connectivity network. A secure connection establishment circuit 612 may be configured to establish a secure connection with a service network node via the connectivity network node, wherein communications over the secure connection are secured against access by the connectivity network node.

In one example, in establishing the secure connection with the service network node the processing circuit may be configured to determine whether the radio access network node has a pre-existing secure connection with the service network node. If the pre-existing secure connection is available, the processing circuit is configured to reuse the pre-existing secure connection with the service network node is reused. Otherwise, if the pre-existing secure connection is not available, the processing circuit is configured to establish the secure connection with the service network node via the connectivity network node.

In one example, in establishing the secure connection with the service network node the processing circuit may be configured to receive a secure connection request from the connectivity network node which originated from the service network node.

The processing circuit may be further configured to receive, from the service network node over the secure connection, a key that serves to secure communications between the radio access network node and the client device. Communications to the client device may be secured based on the key. The service registration request may include a service identifier associated with the service network node or a service. The service registration request may be forwarded along with radio access network node information, where the radio access network node information includes at least one of a node identifier, node address, and/or node certificate associated with the radio access network node.

The memory/storage device 608 may include service registration request forwarding instructions 616 and/or secure connection establishment instructions 618 which may be executable by the processing circuit 602 to perform one or more of its functions. Additionally, the memory/storage device 608 may store private/public key(s) and/or security keys with which to establish one or more secure connections, and/or authenticate other nodes.

### Exemplary Service Network Node and Operation Therein To Establish Secure Connection With Radio Access Network Node

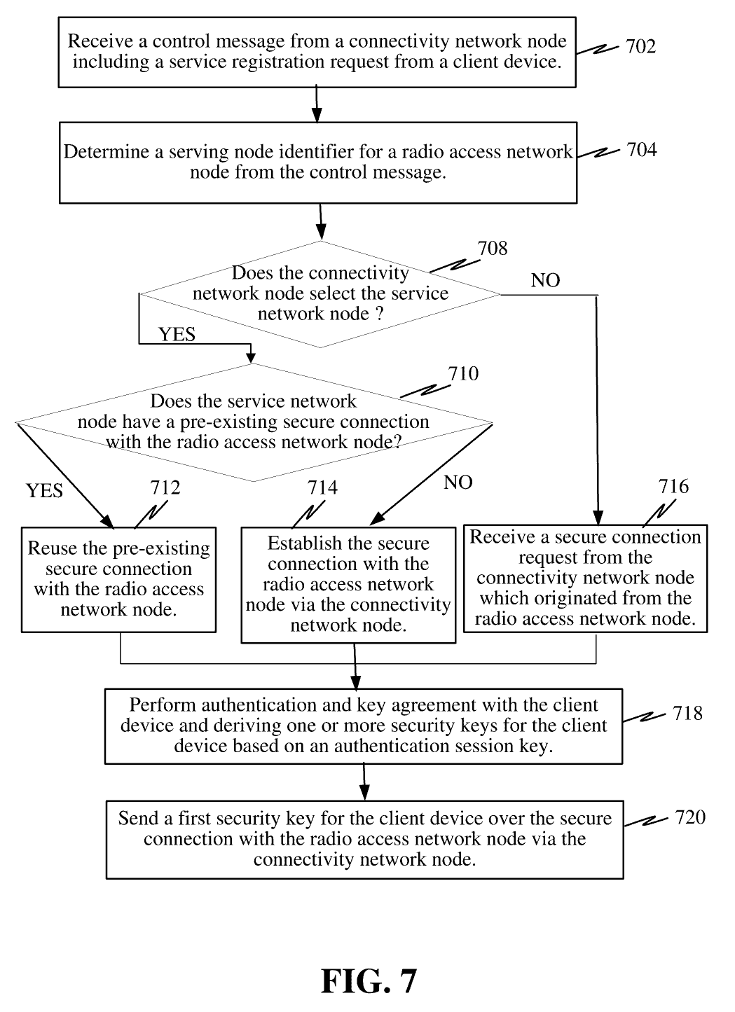

FIG. 7 illustrates a method operational at a service network node for establishing a secure interface/connection with a radio access network node. A control message may be received from a connectivity network node including a service registration request from a client device 702. The service registration request (e.g., Step 242b in FIG. 2. or Step 11 in FIG. 3) may include a access node identifier, a access node address and a access node certificate. A serving node identifier for a radio access network node may be determined/ascertained from the control message 704.

A secure connection may be established with the radio access network node via the connectivity network node, wherein communications over the secure connection are secured against access by the connectivity network node. Establishing the secure connection may be done in different ways depending on whether the connectivity network node selects the service network node 708.

In a first example, where the connectivity network node ascertains (e.g., selects) the service network node, establishing the secure connection with the radio access network node includes determining, upon receipt of the control message, whether the service network node has a pre-existing secure connection with the radio access network node 710. If the pre-existing secure connection is available, the pre-existing secure connection with the radio access network node is reused 712. Otherwise, if the pre-existing secure connection is not available, the secure connection with the radio access network node via the connectivity network node is established 714.

In a second example, where the radio access network node does not ascertain (e.g., does not select) the service network node, establishing the secure connection with the service network node includes receiving a secure connection request from the connectivity network node which originated from the radio access network node 716.

The service network node may then perform authentication and key agreement with the client device and deriving one or more security keys for the client device based on an authentication session key 718. A first security key for the client device may be generated and sent over the secure connection with the radio access network node via the connectivity network node 720.

The derived one or more security keys may include at least one for access stratum (AS) security and one for non-access stratum (NAS) security. The first security key may serve to secure access stratum communications. The control message may include radio access network node information.

In one example, establishing the secure connection may further include sending service network node information to the radio access network node. The service network node information may include an identifier, an address, or a certificate.

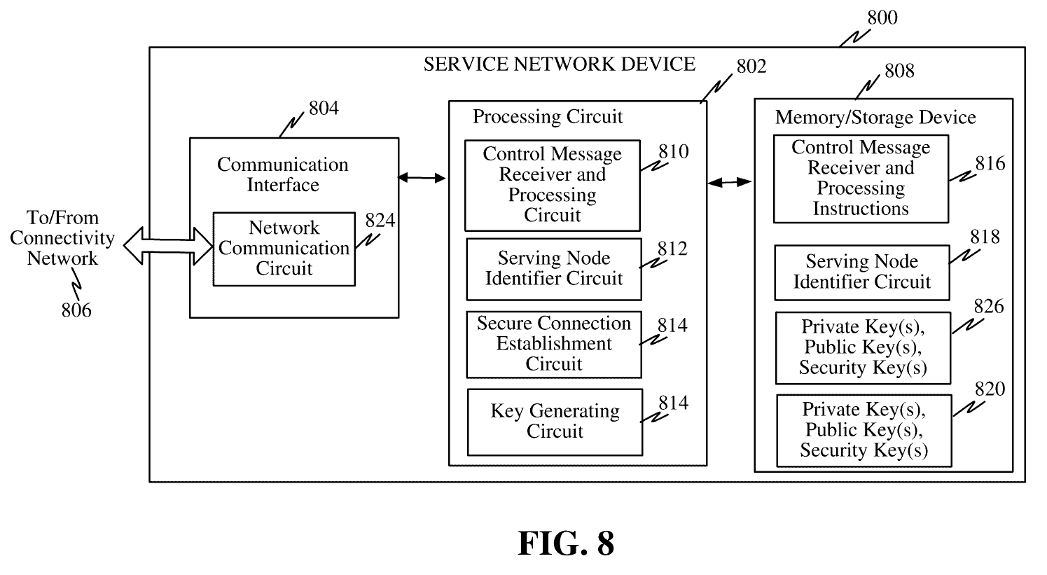

FIG. 8 is a block diagram illustrating an exemplary service network node 800 configured to establish a secure interface/connection with a radio access network node. The exemplary service network node 800 may be configured to perform one or more steps illustrated in FIGS. 2, 3, 4, and/or 7. The service network node may comprise a (network) communication interface 804, a processing circuit 802, and a memory/storage device 808. The communication interface 804 may include a network communication circuit 824 for communicating over a connectivity network 806.

The processing circuit 802 may include a control message receiver and processing circuit 810 configured to receive a control message from a connectivity network node including a service registration request from a client device. A serving node identifier circuit 812 may be configured to determine a serving node identifier for a radio access network node from the control message. A secure connection establishment circuit 814 may be configured to establish a secure connection with the radio access network node via the connectivity network node, wherein communications over the secure connection are secured against access by the connectivity network node.

In one example of establishing the secure connection with the radio access network node, the processing circuit 802 may be configured to determine whether the service network node has a pre-existing secure connection with the radio access network node. If the pre-existing secure connection is available, the pre-existing secure connection with the radio access network node is reused. Otherwise, if the pre-existing secure connection is not available, the secure connection with the radio access network node is established via the connectivity network node.

In another example of establishing the secure connection with the radio access network node, the processing circuit 802 may be configured to receive a secure connection request from the connectivity network node which originated from the radio access network node.

Additionally, the processing circuit may be further configured to perform authentication and key agreement with the client device and deriving one or more security keys for the client device based on an authentication session key. A first security key for the client device may be sent over the secure connection with the radio access network node via the connectivity network node. The derived one or more security keys may include at least one for access stratum (AS) security and one for non-access stratum (NAS) security. The first security key may serve to secure access stratum communications.

The control message may also include radio access network node information. Establishing the secure connection may further include sending service network node information to the radio access network node. The service network node information may include an identifier, an address, or a certificate.

In one example, the processing circuit 802 may also include a key generation circuit 822 configured to generate the one or more security keys to send to the one or more radio access nodes via the connectivity network.

The memory/storage device 808 may include control message receiver and processing instructions 816, serving node identifier instructions 818, and/or secure connection establishment instructions 826 which may be executable by the processing circuit 802 to perform one or more of its functions. Additionally, the memory/storage device 808 may store private/public key(s) and/or security keys 820 with which to establish one or more secure connections, and/or authenticate other nodes.

One or more of the components, steps, aspects, and/or functions illustrated in the figures may be rearranged and/or combined into a single component, step, aspect, or function or embodied in several components, steps, or functions. Additional elements, components, steps, and/or functions may also be added without departing from novel aspects disclosed herein. The apparatus, devices, and/or components illustrated in the figures may be configured to perform one or more of the methods, aspects, or steps described in the figures. The novel algorithms described herein may also be efficiently implemented in software and/or embedded in hardware.

Also, it is noted that the examples may be described as a process depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines, and/or devices.

Furthermore, examples may be implemented by hardware, software, firmware, middleware, microcode, or any combination thereof. When implemented in software, firmware, middleware, or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the examples disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various aspects of the examples described herein can be implemented in different systems without departing from the scope of the disclosure. It should be noted that the foregoing examples are merely examples and are not to be construed as limiting. The description of the examples is intended to be illustrative, and not to limit the scope of the claims. As such, the present teachings can be readily applied to other types of apparatuses and many alternatives, modifications, and variations will be apparent to those skilled in the art.

What is claimed is:

1. A method operational at a radio access network (RAN) node for establishing a secure interface with a service network node, comprising:
receiving a first service registration request from a client device;
forwarding the first service registration request to a connectivity network node serving the client device within a connectivity network; and
establishing a first secure connection with a first service network node via the connectivity network node, wherein communications over the first secure connection are secured against access by the connectivity network node.

2. The method of claim 1, further comprising:
receiving a second service registration request from the client device;
forwarding the second service registration request to the connectivity network node; and
establishing a second secure connection with a second service network node via the connectivity network node, wherein communications over the second secure connection are secured against access by the connectivity network node.

3. The method of claim 1, wherein different service registrations for the same client device establish different secure connections with one or more service network nodes, and the different secure connections are secured against access by the connectivity network node.

4. The method of claim 1, further comprising:
selecting a service network associated with the connectivity network, wherein the first service network node operates within the service network.

5. The method of claim 1, wherein establishing the first secure connection with the first service network node includes:
determining whether the radio access network node has a pre-existing secure connection with the first service network node;
if the pre-existing secure connection is available, reusing the pre-existing secure connection with the first service network node; and
if the pre-existing secure connection is not available, establishing the first secure connection with the first service network node via the connectivity network node.

6. The method of claim 1, wherein establishing the first secure connection with the first service network node includes:
receiving a secure connection request from the connectivity network node which originated from the service network node.

7. The method of claim 1, further comprising:
receiving, from the first service network node over the first secure connection, a key that serves to secure communications between the radio access network node and the client device.

8. The method of claim 7, further comprising:
securing communications between the radio access network node and the client device based on the key.

9. The method of claim 1, wherein the first service registration request includes a service identifier associated with the service network node or a service.

10. The method of claim 1, wherein the first service registration request is forwarded along with radio access network node information, where the radio access network node information includes at least one of a node identifier, node address, and/or node certificate associated with the radio access network node.

11. The method of claim 1, wherein the first service registration request includes service network information.

12. The method of claim 1, further comprising:
securing the first service registration request if a pre-existing secure connection with the first service network node is available.

13. The method of claim 1, wherein the first secure connection is a tunnel between the radio access network node and the service network node.

14. A radio access network (RAN) node, comprising:
a communication interface for communicating with client devices;
a processing circuit coupled to the communication interface, the processing circuit configured to
receive a service registration request from a client device;
forward the service registration request to a connectivity network node serving the client device within the connectivity network; and
establish a secure connection with a service network node via the connectivity network node, wherein communications over the secure connection are secured against access by the connectivity network node.

15. The radio access network node of claim 14, wherein the processing circuit is further configured to:
determine a service network associated with the connectivity network, wherein the service network node operates within the service network.

16. The radio access network node of claim 14, wherein different service registrations for the same client device establish different secure connections with one or more service network nodes, and the different secure connections are secured against access by the connectivity network node.

17. The radio access network node of claim 14, wherein establishing the secure connection with the service network node includes:
determining whether the radio access network node has a pre-existing secure connection with the service network node;
if the pre-existing secure connection is available, reusing the pre-existing secure connection with the service network node; and
if the pre-existing secure connection is not available, establishing the secure connection with the service network node via the connectivity network node.

18. The radio access network node of claim 14, wherein the processing circuit is further configured to:
receive, from the service network node over the secure connection, a key that serves to secure communications between the radio access network node and the client device.

19. The radio access network node of claim 14, wherein the service registration request includes a service identifier associated with the service network node or a service.

20. The radio access network node of claim 14, wherein the service registration request is forwarded along with radio access network node information, where the radio access network node information includes at least one of a node identifier, node address, and/or node certificate associated with the radio access network node.

21. A method operational at a service network node for establishing a secure connection with a radio access network (RAN) node, comprising:
receiving a control message from a connectivity network node including a service registration request from a client device;
determining a serving node identifier for a radio access network node from the control message; and
establishing a secure connection with the radio access network node via the connectivity network node, wherein communications over the secure connection are secured against access by the connectivity network node.

22. The method of claim 21, wherein establishing the secure connection with the radio access network node includes:
determining, upon receipt of the control message, whether the service network node has a pre-existing secure connection with the radio access network node;
if the pre-existing secure connection is available, reusing the pre-existing secure connection with the radio access network node; and
if the pre-existing secure connection is not available, establishing the secure connection with the radio access network node via the connectivity network node.

23. The method of claim 21, wherein establishing the secure connection with the radio access network node includes:
receiving a secure connection request from the connectivity network node which originated from the radio access network node.

24. The method of claim 21, further comprising:
performing authentication and key agreement with the client device and deriving one or more security keys for the client device based on an authentication session key; and
sending a first security key for the client device over the secure connection with the radio access network node via the connectivity network node.

25. The method of claim 24, wherein the derived one or more security keys include at least one for access stratum (AS) security and one for non-access stratum (NAS) security.

26. The method of claim 24, wherein the first security key serves to secure access stratum communications.

27. The method of claim 21, wherein the control message includes radio access network node information.

28. The method of claim 21, wherein establishing the secure connection further includes sending service network node information to the radio access network node.

29. The method of claim 28, wherein the service network node information includes an identifier, an address, or a certificate.

30. A service network node, comprising:
a network communication interface for communicating over a communication network;
a processing circuit coupled to the network communication interface, wherein the processing circuit configured to:
receive a control message from a connectivity network node including a service registration request from a client device;
determine a serving node identifier for a radio access network node from the control message; and
establish a secure connection with the radio access network node via the connectivity network node, wherein communications over the secure connection are secured against access by the connectivity network node.
